(19) United States
(12) Patent Application Publication
(10) Pub. No.: US 2014/0039212 A1
(43) Pub. Date: Feb. 6, 2014

(54) REFINING OF EDIBLE OIL

(71) Applicant: Aicardo Roa-Espinosa, Madison, WI (US)

(72) Inventor: Aicardo Roa-Espinosa, Madison, WI (US)

(21) Appl. No.: 13/975,347

(22) Filed: Aug. 25, 2013

Related U.S. Application Data
(63) Continuation-in-part of application No. 12/390,570, filed on Feb. 23, 2009, now abandoned.

(51) Int. Cl. C11B 3/00

(52) U.S. Cl. CPC C11B 3/00; C11B 3/008; C11B 3/001
USPC 554/185

(57) ABSTRACT

A three step process for precipitating impurities from crude edible oil source is disclosed. In the first step, residual water is removed from the oil source by passing the oil source through a bed of crosslinked superabsorbent granules. In the second step, a specific polymer is added for precipitating gossypol and elemental sulfur impurities. In the third step, a polymer specific for precipitating organic impurities is added.

### RELATED APPLICATIONS

This application is a continuation in part application claiming priority from non-provisional application Ser. No. 12/390,570 filed on Feb. 23, 2009.

### FIELD OF THE INVENTION

The present invention generally relates to a method for refining and removing solids and impurities from crude edible oils. Edible oil sources include but are not limited to oils originating from fruits and vegetables such as cottonseed oil, olive oil, cassava oil, fruit oil, neem oil, rapeseed oil, canola oil, soybean oil, vegetable oil, grape oil, corn oil, sunflower oil, palm oil, peanut oil and coconut oil. Edible oil sources may also include waste frying or cooking oil from homes and restaurants. More specifically, the present invention relates to a method for the precipitation and removal of the impurities from edible oil. More specifically yet, the present invention relates to a method for the precipitation and removal of a natural toxin, gossypol, from cottonseed oil.

### BACKGROUND OF THE INVENTION

Contaminants, solids and impurities found in these oils may be divided into several categories in terms of their prevalence and difficulty of removing. These contaminants may include gossypol, sulfur in elemental form, and organics such as monoglycerides, diglycerides, free fatty acids, and phospholipids. They represent a wide range of particle sizes, colors, contents and toxicity levels. Cottonseed oil for example has a high content of gossypol.

An example of a current process for oil refining is provided in U.S. Pat. No. 5,310,487. A vegetable oil such as soybean oil, rapeseed oil, cottonseed oil, safflower oil, corn oil, sunflower oil and the like is extracted with an organic solvent such as hexane to obtain micella comprising the solvent and dissolved impurities. Following the extraction, the solvent is evaporated to obtain a crude glyceride oil composition. This crude glyceride oil usually comprises from 0.5-10% by weight of impurities including phospholipids such as lecithin as its primary ingredient, waxes such as higher alcohols, organic sulfur compounds, peptides, free fatty acids, hydrocarbons, carbohydrates, dye compounds, metals and the like. These impurities cause polymerization or decomposition during the processing sequence or in use or upon heating and tend to result in oil coloration or unpleasant odors with the concomitant acceleration of oxidation or deterioration. Accordingly, the next step in the prior art process involves degumming to remove these impurities. Degumming involves adding water to the oil to hydrate the gum material which is primarily composed of phospholipids which may be further purified to yield lecithin. Phosphoric acid may also be used to enhance the degumming operation. The degummed oil is then subjected to chemical (caustic) refining, typically with sodium hydroxide, which reacts with free fatty acids to produce soaps which are acidified to remove residual phospholipids. Following, pigments and destabilizing peroxide-like compounds are absorbed by acid activated bleaching clays and, finally, the oil is heated under vacuum with steam sparging to strip trace amounts of free fatty acids, aldehydes, ketones and other volatile compounds.

This process requires multiple steps and is both energy and equipment intensive. Thus there is a need to simplify the process to increase its speed and reduce cost.

### SUMMARY OF THE PRESENT INVENTION

The present invention attempts to purify a crude edible oil in a three step substantially continuous process that separates out impurities containing water, sulfur, gossypol and organic impurities from the crude edible oil source. The process is conducted in a substantially water free environment comprising the steps of: providing a crude edible oil containing the impurities of water, gossypol, sulfur, and organic impurities; a first step of reducing a water content of said crude edible oil source to less than 0.1 percent on a dry weight basis of the crude oil source; a second step of reducing sulfur and gossypol contents of said crude edible oil source to less than 0.1 percent on a dry weight basis of the crude oil source; and a third step of reducing an organic impurities content of said crude edible oil source to less than 0.1 percent on a dry weight basis of the crude oil source.

These and other features, aspects and advantages of the present invention will become better understood with reference to the following drawings, description and claims.

### BRIEF DESCRIPTION OF THE DRAWINGS

FIG. 1 is a generalized schematic of a conventional edible oil refining plant configuration currently employed in the art.

FIG. 2 is a flow chart of the steps for a conventional edible oil refining process currently employed in the art.

FIG. 3 is a generalized schematic of the edible oil refining plant of the present invention.

FIGS. 4 and 5 are flow charts of the present invention process steps. FIG. 5 is a continuation of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

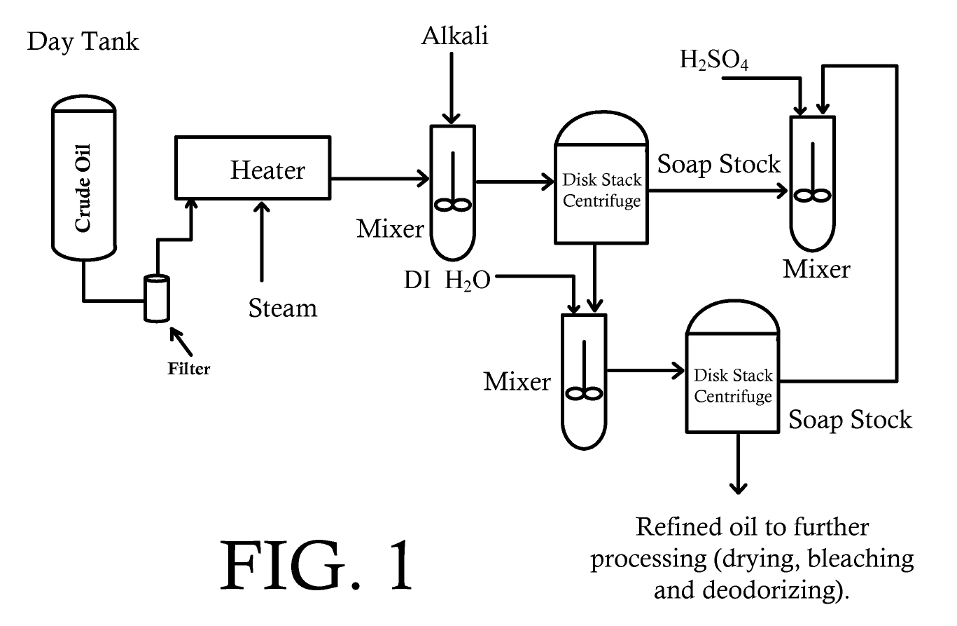

The crude edible oil source may originate from any natural growth such as fruits, vegetables, and parts of trees and brush, and from waste frying and cooking oils. The crude edible oil source may also be a blend of multiple crude edible oil sources including blends of vegetable oils, fruit oils and waste cooking and frying oils. An embodiment of a prior and current art process for refining a crude edible oil source involves filtering and heating an edible crude oil source and mixing it with caustic in a high sheer mixer. Soap is removed by centrifuging in two stages by disk stack centrifuges. The soap is acidulated with sulfuric acid as shown in FIG. 1. Typically the oil exiting the second centrifuge is largely soap free. Further processing, including bleaching with acid activated bleaching clays and heating the oil under vacuum with steam, may be needed to achieve a content having sufficiently low impurities in the refined oil.

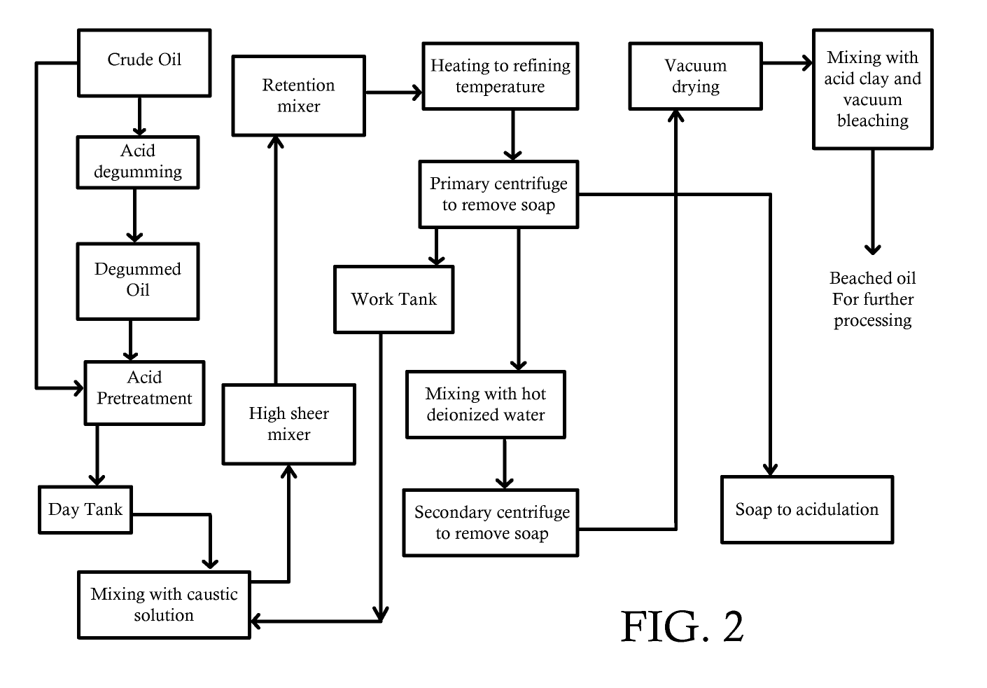

In another embodiment of a prior and current art process for refining edible oil shown in FIG. 2, crude oil is degummed by mixing with water and phosphoric acid. The phosphoric acid may be dispersed in the oil with a high sheer mist. The degummed oil may treated with a caustic solution, typically sodium hydroxide, and mixed with a high sheer mixer at temperatures in the range of about 32-42° C. The caustic treated oil may then pass through a set of retention mixers having top entering agitators and knife blades to maximize mixing under gentle conditions. The mixture may be retained in the retention mixers for about 4 to about 15 minutes depending on the oil being refined. The caustic treated oil may then be heated in a steam heater to a temperature between about 65° C. to about 73° C. and passed through a primary centrifuge for separating the oil from the soap. At this stage, the oil may be tested for percent free fatty acid content, phosphate content, and soap content and compared against targets (e.g., the free fatty acid less than 0.03%, phosphorus less than 3 ppm and soap content of less than 500 ppm). If the percent free fatty acid does not match or fall below the target, the oil may be collected from the primary centrifuge into a work tank and returned to the caustic reactor stage. If phosphorus and soap contents are above targets, a de-ionized water washing and secondary centrifuging step may be employed. Excess soap may be acidulated with sulfuric acid. Depending on the specification, the centrifuged oil may further undergo vacuum drying, and bleaching with acid clay. These processes may be carried out in either batch or semi-continuous fashions.

The process of the present invention is illustrated in FIGS. 1-4. The first step is the removal of water from the crude oil source such as only trace amounts remain. The water in the crude oil source may originate from the waste ingredients or from processing the vegetables and fruits from which the crude oil source is extracted. The removal of the water significantly improves efficiency and speed of the process by avoiding side hydrolysis reactions. Drying costs are also reduced. The preferred embodiment for water removal includes decanting or siphoning off a water layer that rises to the top of the reaction tank and passing the crude oil source through a bed of superabsorbent granules. This may be done at ambient temperatures. The granules of the present invention consist of crosslinked sodium polyacrylate superabsorbent polymer and crosslinked potassium polyacrylate superabsorbent polymer. These polymers can absorb water in amounts of between about 10 to 80 times their own weights. The granules swell when they come in contact with water as they lock onto the water molecules. Once the granules reach their water retention capacity, they need to be replaced with dry granules that can continue to remove water. In the next steps, the impurities are removed in two phases. In the first phase, an impurities layer containing predominantly gossypol and elemental sulfur are precipitated out by the addition of acrylamide/Ethanaminium, N,N,N-trimethyl-2-((1-oxo-2-propenyl)oxo)-, chloride copolymer under specific pH and temperature conditions. In the 2^{nd} phase, organic impurities such as free fatty acids, monoglycerides, diglycerides, and phospholipids are precipitated out by the addition of either one of the following three polymers or a combination of the three polymers. These are: 1) Poly-dimethylamine-Epichlorohydrin having a cationic charge and having a molecular weight of between about 500,000 and about 1,000,000, 2) Poly-Diallyldimethyl-Ammonium Chloride having a cationic charge and having a molecular weight between about 10,000 and about 1,000,000, and 3) a substantially linear Sodium Acrylate Acrylamide copolymer having an anionic charge and a molecular weight between about 8,000,000 and 28,000,000. The precipitated layers of impurities that move to the bottom of the tank, typically as a distinct layer, may then be decanted or otherwise siphoned off. The advantage of the present invention is that it may eliminate many or all of the steps currently practiced. The eliminated steps may include any or all of the steps of heating the caustic treated oil, the primary and secondary centrifuging, soap acidulation, and the post centrifuge separation processes such as vacuum drying and acid clay bleaching. The edible oil refining process of the present invention may require fewer steps and provide for significant equipment, material and energy savings compared to the conventional oil refining processes.

In one embodiment of the present invention, a preliminary step of the process comprises determining the content and composition of the impurities in the crude oil source in order to determine the optimum refining process steps and treatment conditions. The composition of the impurities may contain solids, gossypol, monoglycerides, diglycerides, Free Fatty Acids (FFA), phosphorus, chlorophyll, waxes, organic sulphur compounds, phospholipids, lecithin, dyes, and trace metals. The treatment conditions are determined based on this information. Oils that contain relatively high levels of impurities may require higher temperatures, longer mixing dwell times and/or higher levels of treatment chemicals to achieve the target purity levels compared to oils that contain relatively low levels of impurities. The test may also determine whether insoluble solids are present. If insoluble solids are present, filtering these solids will likely be the next step. The next step in the process following water removal may comprise heating the crude edible oil source to a temperature between about 25° C. to about 35° C. depending on the crude oil source and the composition and content level of the impurities present in the oil. The heated crude oil source is then treated with a caustic solution which may be sodium hydroxide, NaOH, or potassium hydroxide, KOH. The sodium hydroxide or potassium hydroxide may be blended with the crude edible oil source at between about 0.5% to about 2% by weight of the crude edible oil source depending on the composition of the oil source. The caustic treated oil must be mixed vigorously to achieve a well-blended mixture and to insure intimate contact between the caustic and the impurities. A high sheer mixer should be used and typical mixing dwell times may range between about 2 minutes to about 10 minutes. The concentration of the caustic may range from about 25% to about 40%. For optimum process effectiveness and efficiency, it is best to use a caustic having a purity of at least 98%. Subsequently the mixed and heated contents of the tank would be heated to a predetermined temperature of between about 40° C. and about 70° C. depending on the composition of the crude edible oil source. Typically, the optimum temperature range is between about 50° C. to about 55° C.

The step of removing gossypol and elemental sulfur includes treating the mixture with acrylamide/Ethanaminium, N,N,N-trimethyl-2-((1-oxo-2-propenyl)oxo)-, chloride copolymer at a rate of about 1 ppm to about 25 ppm based on the weight of the crude edible oil source. The treatment includes blending the acrylamide/Ethanaminium, N,N,N-trimethyl-2-((1-oxo-2-propenyl)oxo)-, chloride copolymer with the mixture of crude edible oil source and caustic and mixing for a time ranging between about 2 minutes and about 15 minutes. The resulting mixture is then transferred into a holding tank and allowed to settle for a period of between about 10 minutes to about 30 minutes. Two fluid layers typically separate into two phases in the holding tank during this settling period: a dark layer containing mostly gossypol and elemental sulfur precipitates to the bottom of the holding tank and a substantially yellow refined oil layer remains at the top. Any soap generated by the caustic treatment of the edible crude oil source, is likewise contained in the impurities layer leaving only trace amount of the soap in the refined oil layer.

After the layer containing gossypol and elemental sulfur impurities is removed, the impurities containing organics may be removed by the addition of between about 1 ppm and about 25 ppm on a weight basis of the dry crude oil of any of or a combination of 1) Poly-dimethylamine-Epichlorohydrin having a cationic charge and having a molecular weight of between about 500,000 and about 1,000,000, 2) Poly-Diallyldimethyl-Ammonium Chloride having a cationic charge and having a molecular weight between about 10,000 and about 1,000,000, and 3) a substantially linear Sodium Acrylate Acrylamide copolymer having an anionic charge and a molecular weight between about 8,000,000 and 28,000,000. Within about 10-30 minutes, a layer containing the organic impurities is precipitated and removed.

Experimental data indicate that the precipitation of the impurities layer has a characteristic percent completion as a function of time, as judged by the change in the refined oil color. About 50% of the separation is completed in about 10 minutes and nearly 100% of the separation is completed in about 30 minutes.

The layer containing the impurities is mechanically separated from the refined oil layer. The mechanical separation of the impurities layer from the refined oil layer may be accomplished by techniques known in the art for separating two layers having different densities including but not limited to decanting, draining by gravity, and inserting a physical barrier such as a gate valve at the interface between the layers to achieve a more complete separation of the layer and prevent intermixing.

The relatively short duration times of the various process steps may make it possible to run the process in a batch mode or in a semi-continuous mode in which duplicate unit operations are set up to handle any bottlenecks in the process.

If needed, the refined oil layer may undergo further treatments such as centrifuging, vacuum drying and acid clay bleaching. The impurities layer may likewise undergo further treatments including extraction of beneficial components that may have uses such as in animal feed. A final step in the purification process to remove trace impurities or trace odors may be passing the refined oil through a resin exchange column. An example of such an exchange column currently known in the art is manufactured by Purolite®.

In another embodiment of the present invention, the caustic and the polymer are mixed together to form the treatment solution for the edible crude oil source.

Gossypol is an impurity component in cottonseed oil that is a toxin in its pure form and thus needs to be removed in the refining process. Gossypol is neutralized with caustic in the process of the present invention in the manner shown below:

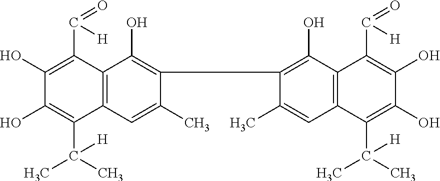 [SMILES: Cc1cc2c(C(C)C)c(O)c(O)c(C=O)c2c(O)c1-c1c(C)cc2c(C(C)C)c(O)c(O)c(C=O)c2c1O]

Gossypol: (2,2′-bis-(Formyl-1,6,7-trihydroxy-5-isopropyl-3-methylnaphthalene) having the general formula of C₃₀H₃₀O₈.

The reaction of sodium hydroxide and gossypol yields the following:

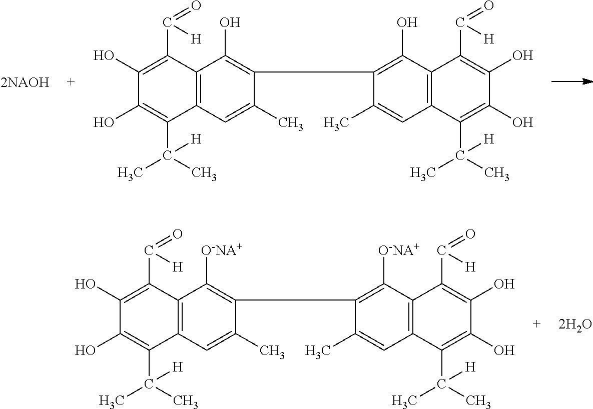

The displacement of the hydrogen atoms in the OH groups by the sodium and the creation of the polar groups in the gossypol facilitate the and precipitation of these molecules.

In one embodiment of the present invention a polymer suited for removing the organic impurities is Polydicyandiamide (DMD), a branched polyamine. Polydicyandiamide is obtained from the reaction of Dicyandiamide monomer and formaldehyde as shown below:

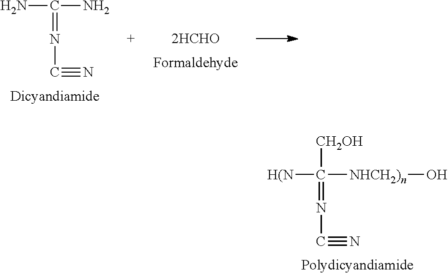

In this embodiment, the molecular weight of the Polydicyandiamide is between about 3000 and 150,000 and it has a high cationic charge level.

In another embodiment of the present invention, a suitable polymer for removing the organic impurities is Polydimethylamine-epichlorohydrin which is a linear s cationic polyamine obtained from the reaction of Dimethylamine and Epichlorohydrin:

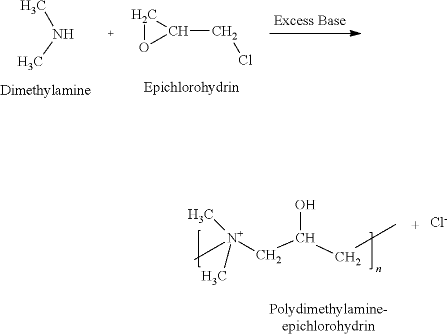

The molecular weight of the Polydimethylamine-epichlorohydrin is ideally between about 500,000 and 1,000,000.

In yet another embodiment of the present invention, a suitable polymer for removing the organic impurities is Diallyldimethyl-Ammonium Chloride (DADMAC), or Poly-Diallyldimethyl-Ammonium Chloride (Poly-DADMAC), a cationic branched polyamine that is a product of the reaction between dimethylamine and allyl chloride. Diallyldimethyl-Ammonium Chloride and Poly-Diallyldimethyl-Ammonium Chloride are produced by the same reaction shown below, but Diallyldimethyl-Ammonium Chloride is made under conditions that inhibit polymerization while the Poly-Diallyldimethyl-Ammonium Chloride is made under conditions that promote polymerization. The molecular weight of the Poly-Diallyldimethyl-Ammonium Chloride is ideally between about 10,000 and 1,000,000.

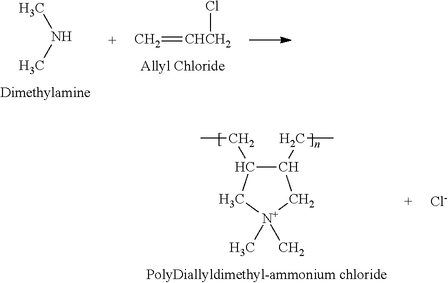

In yet another embodiment of the present invention, a suitable polymer for removing the organic impurities is an anionic polyacrylamide. Specifically, it is Sodium Acrylate Acrylamide copolymer is made by the reaction between an Acrylamide monomer and an Acrylic Acid monomer as shown below. This anionic polyacrylamide of the present invention preferably has a charge density between about 25% and 75% and a molecular weight of between 8 million and 28 million:

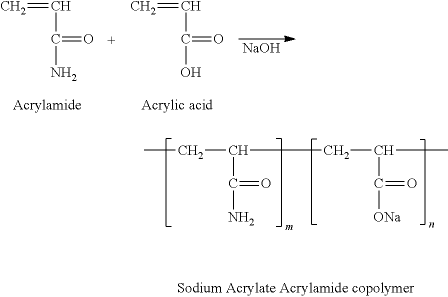

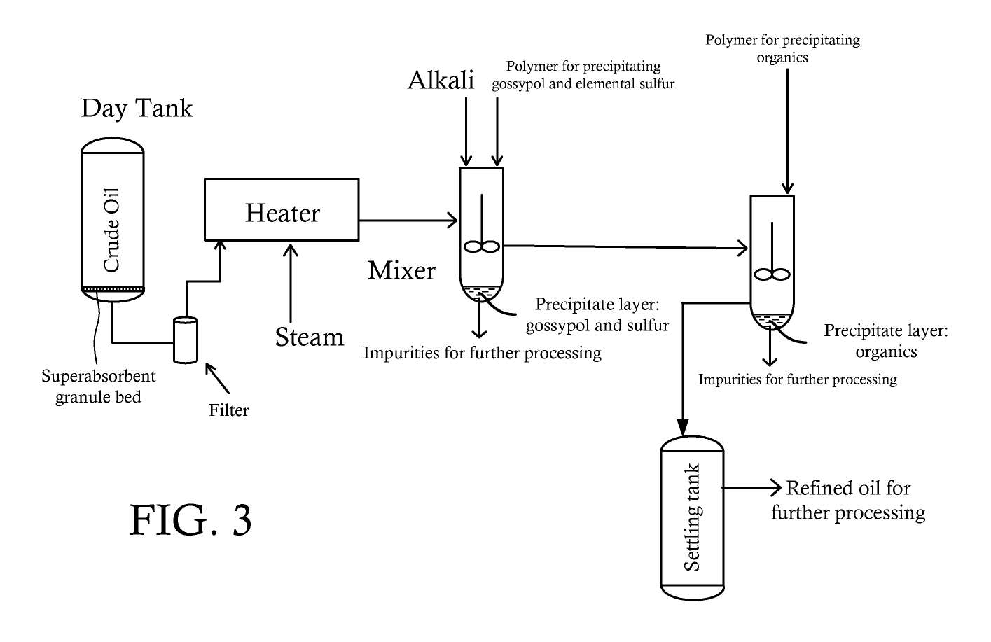

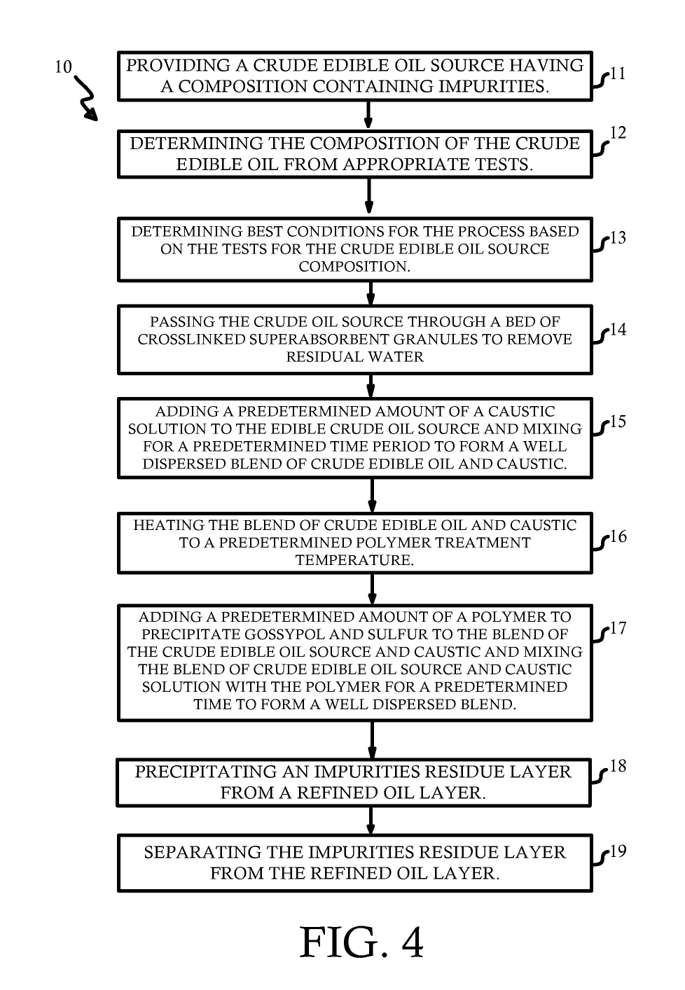

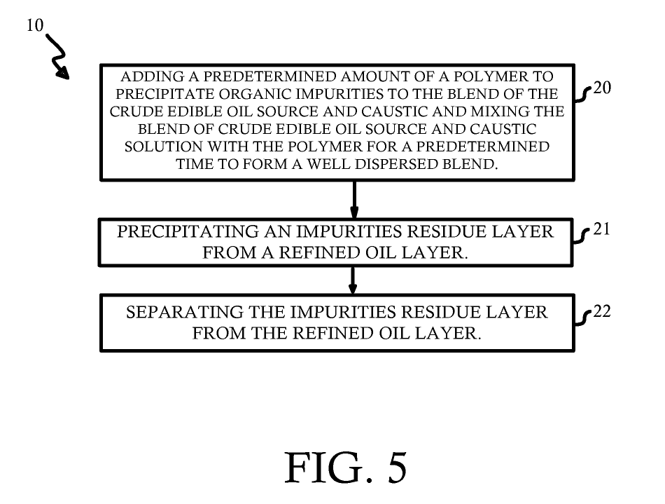

Referring to FIG. 3, the process of the present invention is shown to progress from a crude oil source holding tank from which the oil is filtered through a bed of superabsorbent granules that removes any residual water. Alternatively, the superabsorbent granules are added to the tank and stirred. They lock onto any residual water in the tank. After a period of time, the added granules that hold the residual water maybe filtered out of the mixture. After the water removal step, the moisture level in the oil should be less than 0.1%. The dried oil is then treated with alkali to bring the pH to between about 7 and 8 and heated to a temperature in the 30° C. range. A polymer that prompts the gossypol and elemental sulfur to precipitate is then added and stirred into the mixture for about 10 minutes after which the temperature in the tank is raised to about 50° C. The contents are allowed to settle to precipitate the layer of impurities containing the gossypol and sulfur. This layer is then removed. The oil layer remaining in the tank has a light yellow color. The final purification step is to remove the organics by adding an appropriate polymer, mixing and allowing the mixture to settle to precipitate out a layer of organics that can be removed in the same manner. Referring to FIGS. 4 and 5, there is shown a flow chart depicting the process 10 of the present invention. Step 11 includes providing a crude edible oil source having a composition containing impurities. Step 12 includes determining the composition of the crude edible oil from appropriate tests. Step 13 includes determining best conditions for the process based on the tests for the crude edible oil source composition. Step 14 includes heating the crude edible oil source to a predetermined caustic treatment temperature. Step 15 includes adding a predetermined amount of caustic solution and to the edible oil source and mixing for a predetermined time period to form a well dispersed blend of crude edible oil and caustic. Step 16 includes heating the blend of crude edible oil and caustic to a predetermined polymer treatment temperature. Step 17 includes adding a predetermined amount of a polymer to the blend of the crude edible oil source and caustic and mixing the blend of crude edible oil source and caustic solution with the polymer for a predetermined tome to form a well dispersed blend.

Step 18 includes precipitating an impurities residue layer from a refined oil layer. Step 19 includes separating the impurities residue layer from the refined oil layer. Steps 20-22 relate to the steps of adding a polymer specific for the removal of the organic impurities.

### EXAMPLES

The following examples relate to laboratory simulations of the process of the present invention. The crude oil source was cottonseed oil. The largest component of the impurities contained in cottonseed oil is gossypol. The crude oil was dark in appearance. In each case, a 300 gram sample of the crude oil source was treated in a beaker with sodium hydroxide solution having a concentration of 25% and a purity of 98%. Sodium hydroxide treatment amounts, temperature and mixing retention times varied. The sodium hydroxide treated crude oil was then treated with different polymers and polymer amounts at varying temperatures and at varying mixing retention times. The impurities content in the crude cottonseed oil source was determined from spectrophotometry tests. The results indicated that the crude cottonseed oil sample comprised of about 1.2% phospholipids, 425 mls/gram of phosphorus, and 2.4% free fatty acids. Following the polymer treatment, the contents were allowed to settle. A dark colored impurities layer precipitated to the bottom of the beaker leaving a light yellow colored oil layer at the top of the beaker. In Examples 1, 2 and 3, the time of precipitation and separation of the dark layer from the refined oil later showed a relatively slow progression from 0-10 minutes, and a fast progression from 10-20 minutes at which time about 80-90% of the separation was completed. At 30 minutes, the separation was about 100% completed. Spectrophotometry tests done on the refined oil layer indicated that the percent free fatty acid ranged from 0.06% to 0.13%. Color readings ranged from 9.7R to 10.7R, and 70Y. Soap was undetectable. These runs were repeated for canola oil. The %FFA of the treated canola oils ranged from 0.04% to 0.06%.

### Example 1

### Sodium Hydroxide Mixing Conditions

Concentration of sodium hydroxide: 25%
Amount added: 10 mls (about 0.8% by weight of the crude oil sample)
Mixing temperature: 30° C.
Mixing time: 22 minutes

### Polymer Addition and Mixing

Polymer: Polydimethylamine-epichlorohydrin
Amount added: 10 ppm by weight of the crude cottonseed oil
Mixing temperature: 50° C.
Mixing time: 8 minutes

### Example 2

### Sodium Hydroxide Mixing Conditions

Concentration of sodium hydroxide: 25%
Amount added: 8 mls (about 0.7% by weight of the crude oil sample)
Mixing temperature: 35° C.
Mixing time: 20 minutes

### Polymer Addition and Mixing

Polymer: poly-diallyldimethyl-ammonium chloride
Amount added: 10 ppm by weight of the crude cottonseed oil
Mixing temperature: 50° C.
Mixing time: 8 minutes

### Example 3

Sodium hydroxide mixing conditions
Concentration of sodium hydroxide: 25%
Amount added: 14 mls (about 1.2% by weight of the crude oil sample)
Mixing temperature: 35° C.
Mixing time: 20 minutes

### Polymer Addition and Mixing

Polymer: 1:1 mixture of Polydimethylamine-epichlorohydrin and poly-diallyldimethyl-ammonium chloride
Amount added: 10 ppm of each polymer by weight of the crude cottonseed oil
Mixing temperature: 50° C.
Mixing time: 8 minutes

### Example 4

In this example, nearly 100% of the separation was completed in about 15 minutes.

### Sodium Hydroxide Mixing Conditions

Concentration of sodium hydroxide: 25%
Amount added: 8 mls
Mixing temperature: 35° C.
Mixing time: 20 minutes

### Polymer Addition and Mixing

Polymer: a mixture of Sodium acrylate acrylamide copolymer and Polydimethylamine-epichlorohydrin.
Amount added: 5 ppm by weight of the crude cottonseed oil of Sodium acrylate acrylamide copolymer and 10 ppm of Polydimethylamine-epichlorohydrin.
Mixing temperature: 45° C.
Mixing time: 5 minutes

It should be understood, of course, that the foregoing relates to exemplary embodiments of the invention and that modifications may be made without departing from the spirit and scope of the invention.

I claim:

1. A three step substantially continuous process for separating impurities, said impurities containing water, sulfur, gossypol and organic impurities from a crude edible oil source, said process being conducted in a substantially water free environment, said process comprising:
providing a crude edible oil containing the impurities of water, gossypol, sulfur, and organic impurities;
a first step of reducing a water content of said crude edible oil source to less than 0.1 percent on a dry weight basis of the crude oil source;
a second step of reducing sulfur and gossypol contents of said crude edible oil source to less than 0.1 percent on a dry weight basis of the crude oil source; and
a third step of reducing an organic impurities content of said crude edible oil source to less than 0.1 percent on a dry weight basis of the crude oil source.

2. The process of claim 1, wherein reducing the water content of said crude edible oil source to less than 0.1 percent on a dry weight basis of the crude oil source comprises:
decanting a water layer that forms at a top of the crude edible oil source; and
filtering said crude edible oil source through a layer of superabsorbent granules, said superabsorbent granules being selected from the group consisting of crosslinked sodium polyacrylate, crosslinked potassium polyacrylate and blends thereof.

3. The process of claim 2, wherein reducing the sulfur and gossypol contents of said crude edible oil source to less than 0.1 percent on a dry weight basis of the crude oil source comprises:
heating said crude edible oil source to a predetermined caustic treatment temperature;
adding a predetermined amount of a caustic solution to said crude edible oil source and mixing said crude edible oil source with the caustic solution for a predetermined time period to form a blend of crude edible oil source and caustic solution;
heating said blend of crude edible oil source and caustic solution to a predetermined treatment temperature;
adding between about 10 parts per million and about 25 parts per million on a dry weight basis of acrylamide/Ethanaminium, N,N,N-trimethyl-2-((1-oxo-2-propenyl)oxo)-, chloride copolymer, said acrylamide/Ethanaminium, N,N,N-trimethyl-2-((1-oxo-2-propenyl)oxo)-, chloride copolymer having a weight average molecular weight of between about 3 million and about 10 million to the blend of crude edible oil source and caustic solution and mixing the blend of the crude edible oil source and caustic solution with the polymer for a predetermined time period to achieve a treatment blend of the crude edible oil source, caustic solution and acrylamide/Ethanaminium, N,N,N-trimethyl-2-((1-oxo-2-propenyl)oxo)-, chloride copolymer, said acrylamide/Ethanaminium, N,N,N-trimethyl-2-((1-oxo-2-propenyl)oxo)-, chloride copolymer;
mixing said treatment blend for a predetermined time period;
precipitating a residue layer containing the sulfur and gossypol impurities from a refined oil layer; and
separating the residue layer containing the sulfur and gossypol impurities from the refined oil layer.

4. The process of claim 3, wherein reducing the content of organic impurities content of said crude edible oil source to less than 0.1 percent on a dry weight basis of the crude oil source comprises:
adding to the refined oil layer a polymer selected from a group consisting of: Poly-dimethylamine-Epichlorohydrin having a cationic charge and having a molecular weight of between about 500,000 and about 1,000,000; Poly-Diallyldimethyl-Ammonium Chloride having a cationic charge and having a molecular weight between about 10,000 and about 1,000,000; a substantially linear Sodium Acrylate Acrylamide copolymer having an anionic charge and a molecular weight between about 8,000,000 and 28,000,000 and combinations thereof;
precipitating a residue layer containing said organic impurities from the refined oil layer; and
separating the residue layer from the refined oil layer.

5. The process of claim 4, wherein the polymer is added at a rate of about 1 to about 25 parts per million by weight of the crude edible oil source.

6. The process of claim 4, wherein the predetermined time period to form a well dispersed blend of crude edible oil source and caustic solution is between about 2 minutes to about 10 minutes.

7. The process of claim 1 optionally further comprising:
filtering the crude edible oil source to remove solids; and
pre-treating the crude edible oil source with an acid prior to heating said crude edible oil source to a predetermined caustic treatment temperature.

8. The process of claim 7 optionally further comprising:
centrifuging said crude edible oil layer; and
passing said crude edible oil layer through a resin exchange column.

9. The process of claim 8 optionally further comprising:
treating the refined oil layer with an acid activated clay; and
heating the refined oil layer under vacuum.

10. The process of claim 9 optionally further comprising;
filtering the residue layer to form a filtered residue layer;
centrifuging said filtered residue layer to separate out a centrifuged layer; and
passing said centrifuged layer through a resin exchange column.

11. The process of claim 4, wherein the predetermined time period for mixing the treatment blend ranges from between about 2 minutes to about 15 minutes.

12. The process of claim 3, wherein the predetermined caustic treatment temperature is between about 25° C. to about 35° C.

13. The process of claim 3, wherein the predetermined polymer treatment temperature is between about 40° C. to about 70° C.

14. The process of claim 13, wherein the predetermined polymer treatment temperature is between about 50° C. to about 55° C.
